(19) United States
(12) Patent Application Publication
(10) Pub. No.: US 2019/0236109 A1
(43) Pub. Date: Aug. 1, 2019

(54) EXCLUSIVE SEARCH ENGINE DIRECTORIES, SYSTEMS, AND METHODS OF USE

(71) Applicants: Thomas BRYANT III, Round Rock, TX (US); Henry PENA, Round Rock, TX (US)

(72) Inventors: Thomas BRYANT III, Round Rock, TX (US); Henry PENA, Round Rock, TX (US)

(21) Appl. No.: 16/339,177

(22) PCT Filed: Oct. 3, 2016
(86) PCT No.: PCT/US2016/055163

§ 371 Date: Apr. 3, 2019

(51) Int. Cl. G06F 16/9536; G06F 16/951; G06Q 30/02; G06F 16/9537; G06F 17/27; G06F 16/9538; G06F 16/9032

(52) U.S. Cl. CPC G06F 16/9536; G06F 16/951; G06Q 30/0261; G06F 16/90332; G06F 17/275; G06F 16/9538; G06F 16/9537

(57) ABSTRACT

Systems (100) and methods that provide exclusive search engine directories and results to users are provided herein. In one embodiment, a method includes receiving, by a search engine server, a search request, the search request having one or more keywords (202), parsing the search request to locate the one or more keywords in the request (204), selecting one or more dedicated directories to be queried based on a domain of the one or more keywords (206), selecting a dedicated directory listing from the one or more dedicated directories that matches the domain of the one or more keywords (208), the directory listing being exclusively linked to the domain, and providing the dedicated directory listing to the client.

### CROSS REFERENCE TO RELATED APPLICATIONS

This application is related to international patent application PCT/US2014/027153, filed on Mar. 14, 2014, and to international patent application PCT/US2014/027098, filed Mar. 14, 2014, which are hereby incorporated by reference herein in their entirety including all references and appendices cited therein.

### FIELD OF THE INVENTION

The present technology is directed to search engines, and more particularly, but not by limitation to systems and methods that provide exclusive search engine directory listings which link individual directory listings to search terms that are indicative of a subject matter domain and a geographical location.

### SUMMARY

According to some embodiments, the present technology can be directed to a method comprising: (a) receiving, by a search engine server, a search request, the search request comprising one or more keywords; (b) parsing the search request to locate the one or more keywords in the request; (c) selecting one or more dedicated directories to be queried based on a domain of the one or more keywords; (d) selecting a dedicated directory listing from the one or more dedicated directories that matches the domain of the one or more keywords, the directory listing being exclusively linked to the domain; and (d) providing the dedicated directory listing to the client.

In some embodiments, the present disclosure can be directed to a system of one or more computers which can be configured to perform particular operations or actions by virtue of having software, firmware, hardware, or a combination of these installed on the system that in operation causes or cause the system to perform one or more of the actions and/or method steps described herein. One or more computer programs can be configured to perform particular operations or actions by virtue of including instructions that, when executed by data processing apparatus, cause the apparatus to perform the actions. One general aspect includes actions such as (a) receiving, by a search engine server, a search request, the search request comprising one or more keywords; (b) parsing the search request to locate the one or more keywords in the request; (c) selecting one or more dedicated directories to be queried based on the one or more keywords; (d) selecting a dedicated directory listing from the one or more dedicated directories that matches the one or more keywords, wherein each dedicated directory listing in the one or more dedicated directories is exclusively linked to a specific dedicated directory listing to the exclusion of all other dedicated directory listings in the one or more dedicated directories; and (e) providing the dedicated directory listing to the client.

In another embodiment, the present disclosure can comprise a system comprising: (a) means for receiving, by a search engine server, a search request, the search request comprising one or more keywords; (b) means for parsing the search request to locate the one or more keywords in the request; (c) means for selecting one or more dedicated directories to be queried based on a domain of the one or more keywords; (d) means for selecting a dedicated directory listing from the one or more dedicated directories that matches the domain of the one or more keywords, the directory listing being exclusively linked to the domain; and (e) means for providing the dedicated directory listing to the client.

In another embodiment, the present disclosure can comprise a method comprising: (a) step for receiving, by a search engine server, a search request, the search request comprising one or more keywords; (b) step for parsing the search request to locate the one or more keywords in the request; (c) step for selecting one or more dedicated directories to be queried based on a domain of the one or more keywords; (d) step for selecting a dedicated directory listing from the one or more dedicated directories that matches the domain of the one or more keywords, the directory listing being exclusively linked to the domain; and (e) step for providing the dedicated directory listing to the client.

In another embodiment, the present disclosure can comprise: (a) receiving a search request via a search engine interface, the search comprising keywords; (b) parsing the search request for the keywords; (c) locating a first type of keywords in the parsed keywords; (d) locating a second type of keywords in the parsed keywords; (e) determining a location associated with the search request; (f) selecting an exclusive dedicated directory to be queried based on the first type of keywords and the location; (g) selecting a plurality of directory listings from the selected exclusive directory that match or are linked to the first type of keywords; (h) searching social network user content associated with each of the plurality of directory listings to match the second type of keywords with keywords contained in the social network user content; and (i) providing one or more of the plurality of directory listings to the client based on the matching keywords.

### BRIEF DESCRIPTION OF THE DRAWINGS

The accompanying drawings, where like reference numerals refer to identical or functionally similar elements throughout the separate views, together with the detailed description below, are incorporated in and form part of the specification, and serve to further illustrate embodiments of concepts that include the claimed disclosure, and explain various principles and advantages of those embodiments.

The methods and systems disclosed herein have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

FIG. 1 is a schematic diagram of an example system for practicing aspects of the present disclosure.

FIG. 2 is a flowchart of an example method for providing an exclusive search directory listing in response to a search request according to an embodiment.

FIG. 3 is a flowchart of another example method for providing an exclusive search directory listing in response to a search request according to an embodiment.

FIG. 4 is a flowchart of an example sub-method for returning various search request responses according to an embodiment.

FIG. 5 is a flowchart of an additional example method for providing an exclusive search directory listing in response to a search request according to an embodiment.

FIG. 6A illustrates an example view of a portion of a directory listing database according to an embodiment.

FIG. 6B illustrates an example screenshot of a directory listing selected from the directory listing database according to an embodiment.

FIG. 7 illustrates an example snapshot of a directory listing provided along with an associated advertisement that is linked to the directory listing according to an embodiment.

FIG. 8 illustrates an example snapshot of a directory listing provided along with an associated advertisement that is embedded to the snapshot of the directory listing according to an embodiment.

FIG. 9 is an example computing device that can be used to practice aspects of the present technology.

FIG. 10 is a flow chart of a method for providing a directory listings in response to a search request according to yet another embodiment.

FIG. 11 is an example snapshot of the rank directory listings provided along with associated social media content and advertisement embedded there according to one embodiment.

### DETAILED DESCRIPTION OF PREFERRED EMBODIMENTS

The present disclosure is related to systems and methods that dedicate specific search terms, referred to herein as keywords, to subject matter domains. Unique directory listings that belong to an entity are linked to a specific keyword. The entity is related to the subject matter domain of a keyword in some embodiments. For example, a coffee shop is linked to a subject matter domain of coffee shop. In one embodiment an entity can be linked to multiple subject matter domains. Regardless, each entity is provided a directory listing that comprises, for example, a database record. The database record can include various permutations of information that describe the entity in terms of subject matter domains. In one example, a coffee shop may also serve pastries, such that the directory listing includes both coffee and pastries. Additional information such as a geographical location of the entity, a phone number or other contact information, contact information and location(s), telephone numbers of people, businesses and other organizations in a particular area or district with their associated advertising, profile(s), review(s), and comments of people, businesses and other organizations, and any other descriptive information of the entity can be included in the directory listing.

When a search engine user searches for keywords (either individually or included in a search query such as a natural language search query), the search engine receives the search query and parses the query to locate one or more keywords included therein. The system can maintain a database of keywords that have been pre-linked to directory listings. As mentioned above, in one embodiment a keyword is linked to only a single, unique directory listing in the database. In other embodiments, the search engine can alternatingly link a keyword to a plurality of directory listings such that the search engine can cycle through the plurality of directory listings to distribute searches amongst many directory listings, rather than imposing permanent linkages.

When a keyword is located in the database, the search engine obtains the directory listing and then provides the selected directory listing to the requesting user to fulfil the search request.

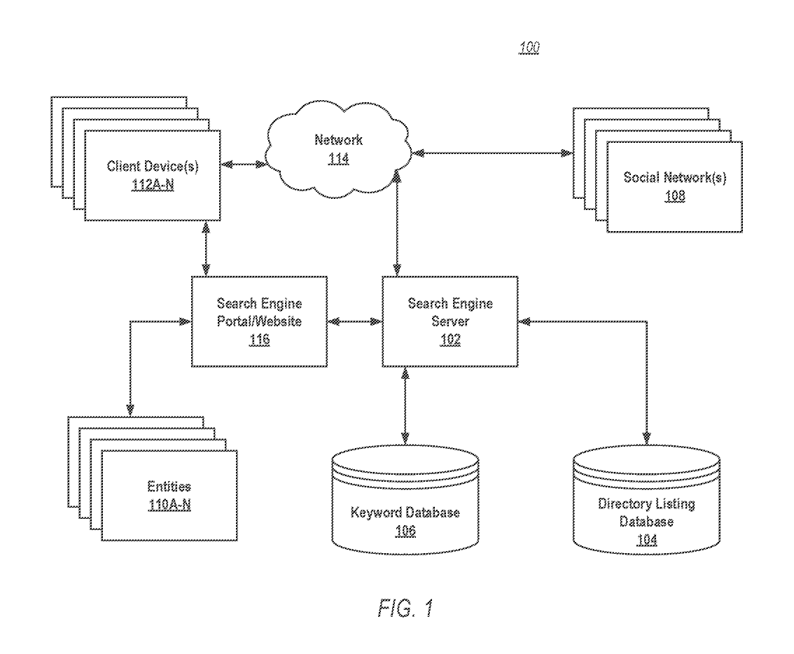

FIG. 1 is a schematic diagram of an example system of the present disclosure. The system 100 comprises a search engine server 102, a directory listing database 104, a keyword database 106, a social network(s) 108, a plurality of entities 110A-N, and client devices 112A-N utilized by search engine users.

The search engine server 102 can be communicatively coupled with the client devices 112A-N over any private or public network, such as the Internet (illustrated generally as network 114). The search engine server 102 is a specific purpose computing device that is configured to provide any one or more of the algorithms described herein.

In one embodiment the search engine server 102 maintains a plurality of different types of entity directories defined and generated by the search engine server 102 or directly by the entities 110A-N. For example, the search engine server 102 can automatically create a directory listing for an entity based on publically available information mined from websites, social network profiles, public databases, and the like. In another embodiment an entity can create a directory listing using a template or form provided by the search engine server 102.

In one embodiment, the search engine server 102 can link or assign a unique keyword or key phrase to a single dedicated directory listing in the directory listing database 104 to the exclusion of all other entities in the directory listing database 104. That is, when a search term for the keyword or phrase is received, the same dedicated directory listing is selected for the search to the exclusion of all other entities included in the database, even entities having directory listings that match the keyword. This is an exclusive linking relationship between a keyword and a directory listing. To be sure, the word “keyword” as used herein can be interchangeably used to mean both a keyword and a key phrase, which is a combination of two or more words.

In other embodiments, the search engine server 102 can sub-divide the directory listing database into geographical locations. Thus, a keyword can be associated with more than one directory listing when differentiation occurs based on geographical location. Thus, when a search query for pizza is received from New York City, a NYC portion of the directory listing database is searched for a directory listing linked to the pizza keyword in the search query. When a search query for pizza is received from San Francisco, a SFO portion of the directory listing database 104 is searched for a directory listing linked to the pizza keyword in the search query.

The geographical divisions of the directory listing database 104 can be as granular as desired such that searching for a certain search term in one section of a large city will return a directory listing that is different from a directory listing obtained when the search is received from a different part of the same city.

In one or more embodiments, the search engine server 102 can deduce or determine a geographical location for the search query from words included in the search query. In another embodiment, the search engine server 102 can deduce or determine a geographical location for the search query from location data obtained from the client devices 112A-N generating the search queries.

As mentioned above, a keyword can be exclusively assigned to a particular single directory listing by the search engine server 102 and cannot be used to look up or search for any other directory listings or any other web information. Thus, the search engine server 102 truncates a response of the search query, only providing the dedicated directory listing associated with the searched keyword.

In one embodiment, the search engine server 102 can divide the directory listing database 104 into segments based on a subject matter domain. For example, the directory listing database 104 can comprise restaurant, bar, school, movie theater, coffee shop, and other various segments (e.g., sub-directories) based on differing subject matter domains. Again, to be sure, a subject matter domain as described herein relates to a good, service, or other attribute that allows for differentiation and/or grouping of entities relative to one another.

In some embodiments, a search query may comprise keywords that are not linked to any particular directory listing. For example, the keyword could be indicative of a service for which no entity has claimed or purchased the keyword. In these embodiments, the search engine server 102 is capable of searching other non-entity directory listing databases, as with conventional search engine operations.

According to some embodiments, the search engine server 102 cooperates within and functions to provide a social referral network environment such as the social referral network environment described in PCT application US2014/027153, which is hereby incorporated by reference herein in its entirety including all references and appendices cited therein.

A social network user (e.g., entity) can pay or bid for any of a specific keyword to be linked to a specific business directory to the exclusion of all other sites and/or content embedded in the search engine server 102 to include a snap shot of the location of a specific listing in that business directory and any associated advertisement(s) for the entity.

In one embodiment, the search engine server 102 can interface with a social network such as any of the social network(s) 108. The search engine server 102 can provide a social network campaign or other campaign or challenge, competition or other similar activities to a social network user of social network(s) 108, via a search engine portal 116, to encourage the user to connect to the search engine portal 116. For example, to encourage a user to search “Coffee” a coffee campaign can be presented to a social network user that they will receive a certain number of cups of coffee free. In some embodiments, the search engine portal 116 is effectively incorporated into a campaign manager user interface. In some other embodiments, a particular selected advertising campaign is exclusively linked to a specific directory listing in the same way as a keyword is linked.

In one embodiment a social networks user's selection of a particular advertising campaign triggers the search engine server 102 to embed a selected portion of the dedicated directory listing to which it is exclusively assigned.

Note in some embodiments, the search engine server 102 can operate as a universal search engine for keywords that are not exclusively assigned to directory listings. Thus, the search engine server 102 operates as a directory listing search only for those directory listings exclusively assigned keywords, which provides an appearance of a more rounded search engine experience but still ensures only the relevant specific directory listings are embedded for the assigned keywords included in the search query.

Prior to providing listing-based search query services, users can create their directory listing. In some embodiments, entities can bid on keywords. In some embodiments, multiple users can bid together for a particular keyword to be exclusively associated to their directory listing. In one embodiment, this may be useful where there are multiple subscribers of a particular business directory that are interested in a common keyword pointing exclusively to their business directory (usually within the same subject matter domain).

This process can be facilitated by a directory listing manager that charges the directory listing database users via a directory subscription model.

In some embodiments, when a system determines a user's bid as the winning bid, the system causes the keyword to be exclusively assigned to the user's directory for one or any combination of the following: (i) a specific time period, (ii) a certain language, (iii) a specific geographic location. In some embodiments, when the keyword is exclusively assigned by the system to the users directory for a specific time period, the system determines the specific time period has been reached and then reverts back to the original configuration in which that keyword is again available in the bidding process (and no longer assigned to the user's directory) and exclusively assignable to the next user's directory in response to the next user's winning bid.

In some embodiments, a user having a business listed in the directory (the subscriber or owner of a listing) or the directory administrator can determine which keywords are available to be exclusively assigned to the directory. The user or administrator can do this by entering the keywords into a user area of the search engine system or via the directory user interface that is operably connected to the search engine system. Different keywords may have different tariffs or fees for being exclusively assigned to the directory.

In another embodiment, social network users can bid through their respective social network or the directory listing platform individually and once a collective total bids reaches a threshold or a time limit is reached the keyword is exclusively assigned to the directory listing with the highest bid. In this manner individual users collectively take control of their directory listing and how keyword(s) are exclusively assigned.

In some embodiments, users in a social network or within a specific business directory platform can bid against one another to assign their listing and any associated advertisement to be embedded directly into the search engine page in response to the keyword being searched in the search engine field.

So in one embodiment, in the case of the keyword coffee, which is assigned to the coffee business directory, social network users can bid against one another (in some embodiments facilitated by the search engine server 102) to have a specific portion of the business directory listing embedded in search query response results when a user searches “coffee” a portion of the coffee directory listing portion of the directory listing database. In this case, the bid has resulted in the portion of the coffee business listing for DOLLAR COFFEE ROASTERS being embedded in the search engine user interface. In one embodiment an advertisement for DOLLAR COFFEE ROASTERS can also be embedded in the search query response result.

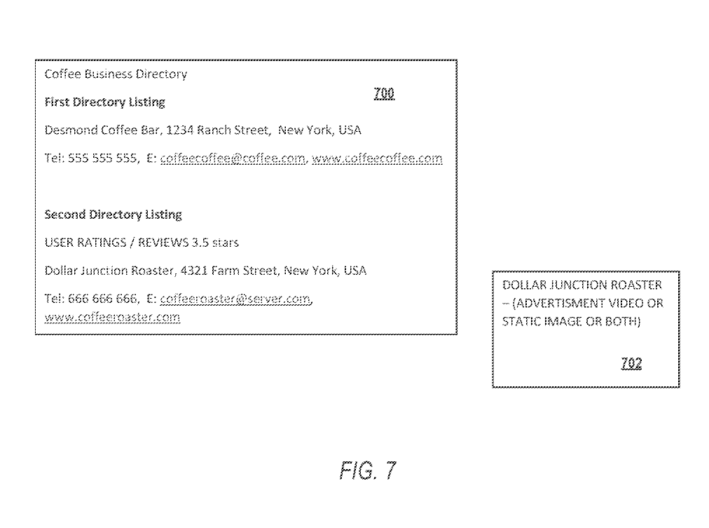

An advertisement provided along with a search engine response is illustrated in FIG. 7, which is described in greater detail below.

The above scenarios can be adapted to for additional embodiments. In some embodiments, geographical location data can be utilized in the search query processing methods. In these embodiments, prior or during the execution of a search by the search engine server 102, geographical data of interest is identified. In one embodiment, a keyword indicative of a location of the user is identified, or GPS information is obtained from a device or browser of the client device that provided the search query.

Using the location data and keyword(s) in the search query, an appropriate section of the directory listing database exclusively associated with keyword(s) for that particular geographical region are embedded in the query results either as a link or as a snapshot of the specific directory listing and advertisement (so as above but directory listings are broken down into geographic regions and then accessed).

In another example embodiment, sub-directories can be utilized to fulfil search request. In these embodiments the search engine server 102 can maintain and return sub-directories related to specific subject matter sub-domains, which allows the search engine server 102 to create domains of varying granularity. In one embodiment a domain of steakhouse restaurant is a main domain, whereas Japanese steakhouse and Chop house would be sub-domains of the main domain. A specific sub-directory listing type is exclusively linked to one or more keywords and then the keyword(s) are embedded by the search engine server 102 in a portion of the subdirectory.

As mentioned above, the search engine server 102 can allow for linking of a keyword to more than one specific directory listing or more than one sub-directory listing. In one embodiment, when a search query is received for the keyword the search engine server 102 selects one of the linked directory listings according to an algorithm. By way of example, in some embodiments, search engine server 102 selects one of the linked directory listings according to data representing at least one of the age of the user operating the search engine user interface or other user interface, geographical location of the user device rendering the search engine user interface or geographical location entered into the user interface; personal and/or business profile information associated with the user device or user of the search engine user interface, and personal and/or business profile information associated with a user account. In some embodiments, the user account information is accessible by virtue of the user search engine interface operating within the user account environment. When a search query is received for the keyword the search engine server 102 can randomly select one of the linked directory listings. In another embodiment the search engine server 102 uses a hierarchy or rotating schedule to select a linked directory listing. In yet another embodiment the search engine server 102 can return multiple directory listings in the search results. These results can be embedded with a snapshot of the directory listings, a website snapshot, and/or an advertisement. Again, the search engine server 102 is configured to exclude all other Internet search results for that particular keyword, in some embodiments.

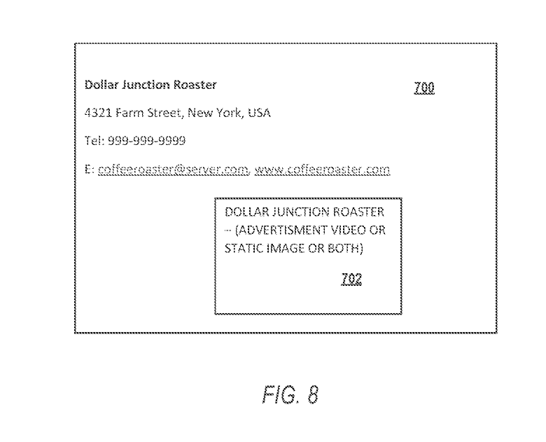

In another embodiment, the search engine server 102 exclusively correlates campaign subjects or topics with a directory listing or sub-directory listing. A particular selected campaign is exclusively linked to a specific directory listing in the same way as a keyword. A user's selection of a particular campaign triggers the search engine server 102 to embed a specific portion of a directory listing exclusively linked to that campaign. In this embodiment, directory listing owners would pay or bid for a campaign to be exclusively linked to their directory listing to the exclusion of all others and the embedding of the link or ad would occur on a campaign user interface rather than the search engine interface, as described above. An example directory listing embedded in a campaign is illustrated in FIG. 8, which is described in greater detail below.

In some embodiments, the search engine server 102 comprises translation capabilities that allow for translation of search queries from a source language to a target language. The search engine server 102 can use either the source language or target language version of the search query to perform the directory listing search. When a result is located the search engine server 102 can then provide the directory listing, advertisement, or other content in either the target language or the source language through translation of the directory listing and/or advertisement back to the source language if the directory listing and/or advertisement are in the target language.

Thus, the search engine server 102 is configured to translate the search request from a source language to a target language. Again, selecting of the dedicated directory listing occurs in the target language and the dedicated directory listing is provided in any of the source language or the target language, in some embodiments.

In one embodiment, the search engine server 102 translates a keyword found in a source language search request (e.g., French) and obtains a search result in English and then translates located English directory listing into the source language of French, and then renders the translated directory listing on a search engine user interface.

Alternatively, the search engine server 102 can operate using foreign language listings and search directory listings in many foreign languages, and render in foreign language. So in this case keyword would be in a foreign language and as it is exclusively linked to a directory listing, listing would likely be in foreign language.

According to some embodiments, the search engine server 102 can use a search cache or user profiles to store and pre-retrieve search results for end users. In one embodiment the search engine server 102 can save a keyword search profile and then use the saved keyword search profile in search history to determine what advertising is placed into a snapshot that is returned as a search result.

The search engine server 102 can select advertising associated with a previous searched directory listing (using a user search history) and then place the previous searched directory listing in a snapshot of a new searched directory listing.

The search engine server 102 can also leverage location based information in these processes. For instance, if a geographic location is different for a new search, the search engine server 102 could determine a new directory listing in the new geographic location for an old searched keyword history and then use the determined corresponding advertising/directory listing in a snapshot provided for the new keyword search.

In one embodiment, it will be assumed that a user first searched coffee and the determined geographic location was San Francisco. The search engine server 102 determines the coffee keyword is exclusively linked to a coffee directory listing for San Francisco geographic location. The system provides the San Francisco coffee directory list snapshot to a search engine interface together with any associated advertising. But then in a subsequent session the same user searches for a cinema in a specific geographical location that is different from the first search. For example, the user searches for a cinema in San Diego. The search engine server 102 determines the directory listing and any associated advertisement for the previous keyword search but for the specific geographical location determined for the new keyword search. So for the example above, when the user that has previously searched using the keyword “coffee” and the determined geographic location is San Francisco, conducts a new search using the keyword cinema and the geographic location is San Diego, the search engine server 102 will, in addition to performing the new keyword search and selecting the directory listing exclusively associated with that new keyword search, also select a directory listing and/or advertising exclusively associated with the prior searched keyword “coffee” now for the new geographic location (San Diego) and not the prior geographic location that was used (San Francisco). The search engine server 102 can incorporate this content in a snapshot that is rendered as part of the new results of the new keyword search for “cinema” in San Diego. So in the aforementioned example, an advertisement and directory listing for “coffee” in that particular new geographical location (San Diego) would be incorporated into a snapshot of the cinema directory listing for San Diego within a search engine user interface.

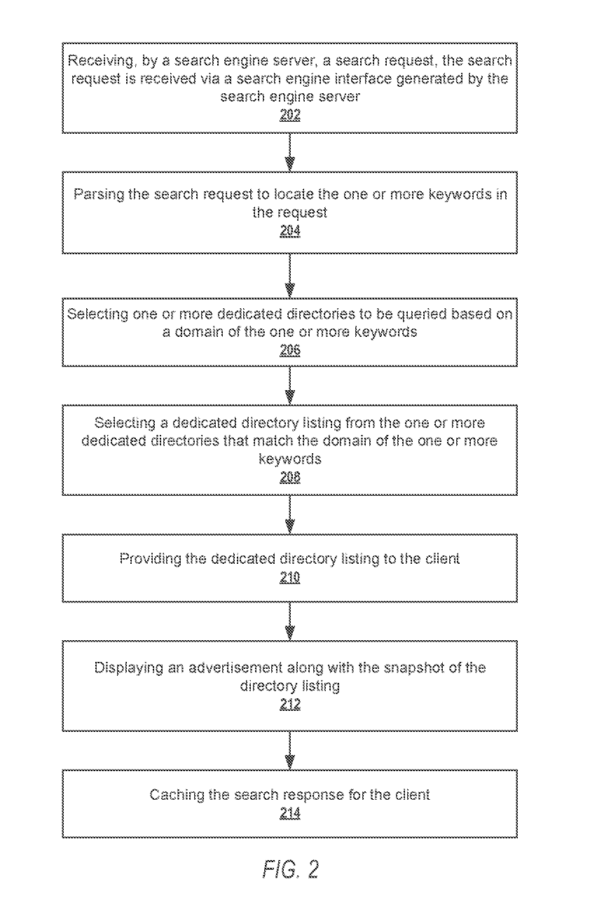

FIG. 2 is a flowchart of an example method of the present disclosure. The method comprises a step 202 of receiving, by a search engine server, a search request. In one embodiment, the search request is received via a search engine interface generated by the search engine server. In another embodiment, the search request is received from an application or an application programming interface from a third party system.

In some embodiments the search request comprises a string of characters such as a natural language statement. The string of characters comprises words and/or phrases that correspond to keyword(s) that are stored in a keyword and/or directory listing database.

Next, the method includes a step 204 of the search engine server parsing the search request to locate the one or more keywords in the request. The parsing of the request includes locating words or groupings of words that are located in the aforementioned keyword/directory listing database. When the search engine server finds a match in the database for one of the keywords or phrases in the search request, the method includes a step 206 of the search engine server selecting one or more dedicated directories to be queried based on a domain of the one or more keywords.

As mentioned above, a keyword can be linked to a directory listing in an exclusive or dedicated manner in some embodiments. The keyword and/or directory listing can be associated with a subject matter domain that corresponds to a good or service offered to consumers.

Selection of a subject matter or domain, when determined by the search engine server, allows the search engine server to search an appropriate portion of the directory listing database.

In some embodiments, the determination of a subject matter domain is not required and therefore specific words or phrases can be linked to a directory listing irrespective of a subject matter domain of the words or phrases. For example, the phrase “best of the best” can be linked to a directory listing for a bank, irrespective if the search query comprises a domain related to banking. A directory listing might desire to have this exclusive relationship for a keyword or phrase because it is a trademark use of a phrase or word that is important to their business.

Next, the method includes a step 208 of the search engine server selecting a dedicated directory listing from the one or more dedicated directories that match the domain of the one or more keywords. As mentioned above, directory listings can be exclusively linked to a subject matter domain.

In one embodiment, the search query includes the keywords of “health club.” The search engine server will search an appropriate database of directory listings for health clubs or workout facilities.

The database includes three separate directory listings that correspond to businesses that have specified that they are in the health club subject matter domain. In one embodiment only a single one of the directory listings is linked to the “health club” domain and the keywords “health club.”

The method includes a step 210 of the search engine server providing the dedicated directory listing to the client. In some embodiments, the search engine server generates a search result that comprises a graphical user interface that comprises a snapshot of the directory listing linked to the keywords “health club” and publishes the GUI for the client. As mentioned, the method can include additional optional steps such as a step 212 of displaying an advertisement along with the snapshot of the directory listing. In some embodiments, the method can include additional optional steps such as a step 214 of caching the search response for the client.

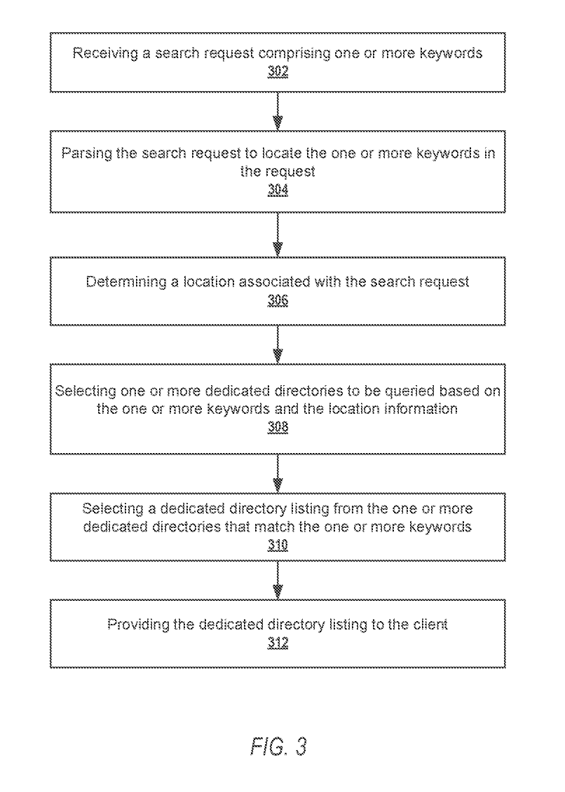

FIG. 3 is a flowchart of another example embodiment of the present disclosure. This method is similar to the method of FIG. 2 with the exception that a subject matter domain is not utilized. The method comprises a step 302 of receiving a search request comprising one or more keywords. Next, the method comprises a step 304 of parsing the search request to locate the one or more keywords in the request.

The method can also optionally comprise a step 306 of determining a location associated with the search request. This can comprise location information determined from words in the search request such as “best coffee shop in Los Angeles.” The location information can also comprise GPS information determined from a device that accesses the search engine portal/website.

According to some embodiments, the method includes a step 308 of selecting one or more dedicated directories to be queried based on the one or more keywords and the location information.

Next, the method includes a step 310 of selecting a dedicated directory listing from the one or more dedicated directories that match the one or more keywords. As mentioned above, each dedicated directory listing in the one or more dedicated directories is exclusively linked to a specific dedicated directory listing to the exclusion of all other dedicated directory listings in the one or more dedicated directories.

In some embodiments, the method comprises a step of 312 providing the dedicated directory listing to the client.

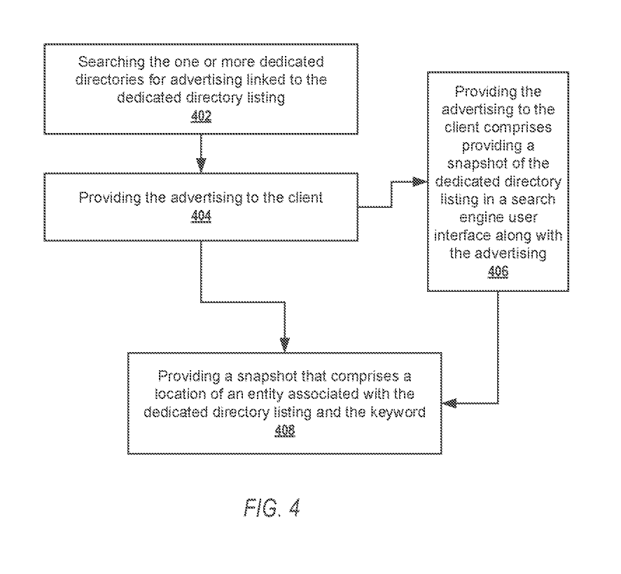

FIG. 4 is a flowchart of an example sub-method that can be incorporated into the methods described herein. The sub-method can comprise a step 402 of searching the one or more dedicated directories for advertising linked to the dedicated directory listing and a step 404 of providing the advertising to the client.

In some embodiments, the method step 404 comprises a step 406 of providing the advertising to the client comprises providing a snapshot of the dedicated directory listing in a search engine user interface along with the advertising. The snapshot comprises a user-selected portion of the dedicated directory listing, in some embodiments. Some embodiments include a step 408 of providing a snapshot that comprises a location of an entity associated with the dedicated directory listing and the keyword.

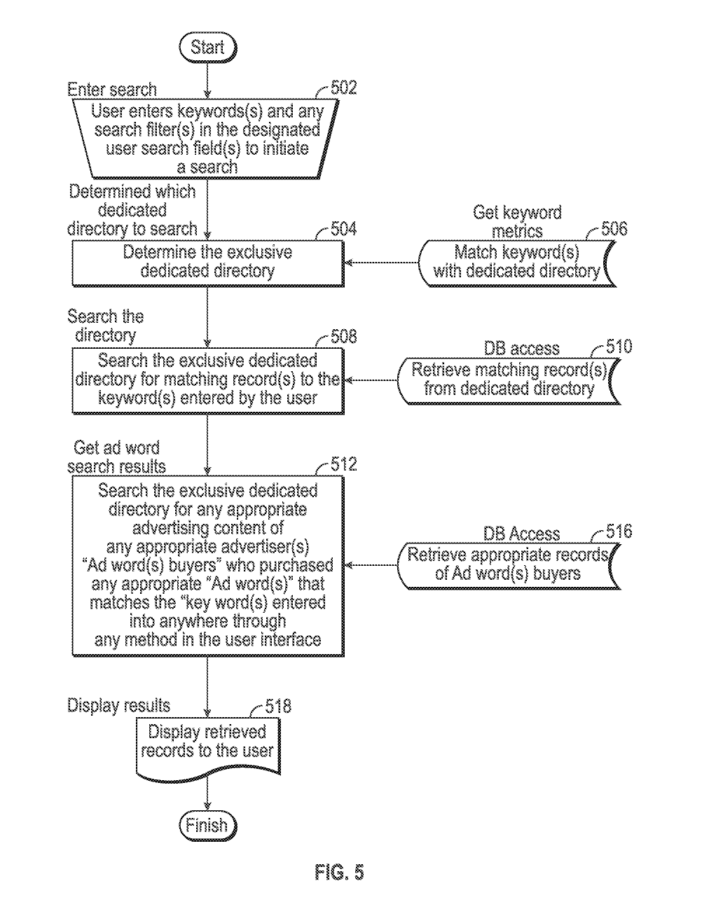

FIG. 5 is a flowchart of an example method of the present disclosure. The method includes a step 502 of a user entering a keyword(s) and selecting any search filter(s) in a search field of a search engine portal/webpage to initiate a search through the search engine server.

The method also comprises a step 504 of determining an exclusive dedicated directory from matched keywords determined in a parallel step 506. Next, the method comprises a step 508 of searching the dedicated directory database for matching record(s) to the keyword(s) entered by the user in the search request. The database is searched in a parallel step 510 where matching directory listing records are retrieved.

In step 512 the search engine server will search the exclusive dedicated directory for appropriate advertising content of an advertiser(s) who are associated or linked with the keywords in the request. Directory listings are returned in step 516. Finally, the retrieved records are displayed in step 518.

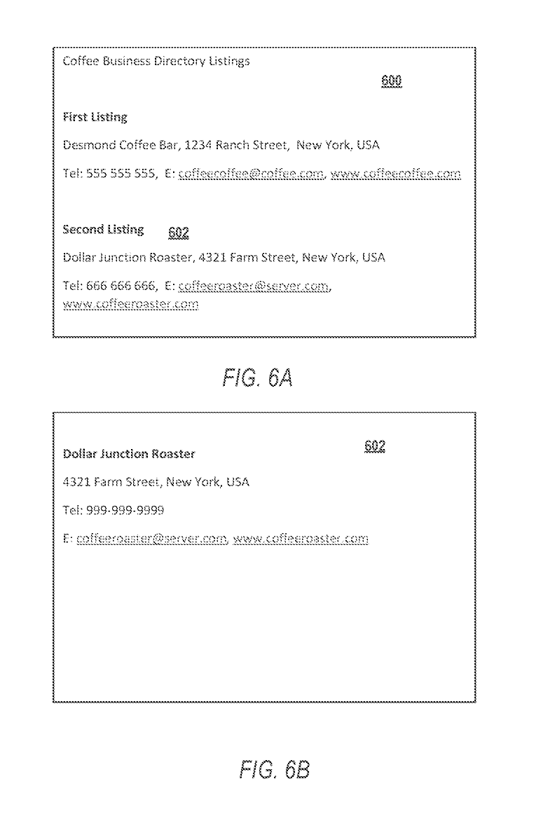

FIG. 6A illustrates an example directory listing database 600 in visual format that comprises a first directory listing and a second directory listing. Each directory listing comprises individual data points such as phone number, address, ratings, and so forth. The directory listings are tied to a geographical location in some embodiments based on their address.

FIG. 6B illustrates an example directory listing 602 that includes one of the directory listing entries in the directory listing database, selected based on any of the embodiments described herein, such as matching of subject matter domain, keyword(s), and/or location.

FIG. 7 illustrates an example directory listing 700 and corresponding advertisement 702 linked to the example directory listing 700. The advertisement 702 can comprise an image such as a banner advertisement, a video, audio, or other similar advertisement type.

FIG. 8 illustrates an example directory listing snapshot 700 and corresponding advertisement 702, where the advertisement 702 is embedded in the example directory listing snapshot 700.

In some alternative embodiments, instead of exclusively linking or assigning the keyword(s) to a dedicated directory listing, the method retrieves or selects a plurality of directory listings based on one or more primary or first type keywords. The system uses one or more secondary type keywords to look up social network or media content associated with the selected directory listings and ranks the selected listings according to the occurrence (or other parameter) of the second type keywords in the social network or media content for each listing.

By way of example, in one alternative embodiment, one or more primary keywords, rather than being exclusively assigned or associated with a dedicated directory listing, are instead exclusively associated with a plurality of directory listings in a directory. The directory may be for example a business directory or other type of directory referred to infra. The one or more secondary type keywords are any keywords that have been designated as keywords to be matched to social network or media content that is associated with the plurality of directory listings of the directory. In response to receiving keywords in the search engine interface, the search engine server and/or other system components are configured to determine which of the keywords are a primary type of keyword (such as those keywords that have been pre-linked or pre assigned by the system to an exclusive directory) and which of the keywords are a secondary type of keyword (such as those which have been pre designated as keywords that are to be matched to social network or media content that is associated with the plurality of directory listings of the exclusive directory). By way of example, social network or media content can be comments or indicators entered in a social network application related to a business service, such as a rating or review by one or more social network users.

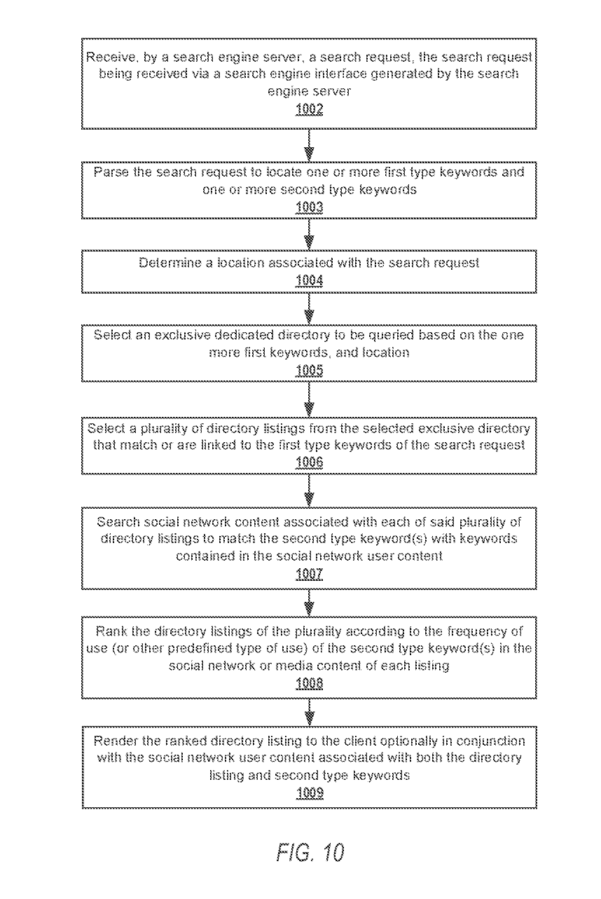

FIG. 10 illustrates one method of providing search directory listings in response to a search request containing one or more first type keywords and one or more second type keywords. Initially, the search engine server receives a search request, the search request being received via a search engine interface generated by the search engine server in step 1002. The system then parses the search request to locate one or more first type keywords and one or more second type keywords in step 1003.

The system can determine which first type keywords are and which second type keywords are in different ways. For example, the system can handle the first keyword or predefined number of keywords entered as “first type keywords” and then the subsequently entered keyword(s) as “second type keywords” or vice versa. Alternatively the system can match entered keywords against a predefined listing, database etc. of first type keywords and any predefined listing, database etc. second type keywords to determine which entered keywords are first type and which second type are. In one embodiment, each user having a directory listing in the directory has access to the keyword databases (for example via their user directory account or user platform or account associated with the search engine system) and can predefine the first type keywords and the second type keywords associated with the directory and the social network or media content, respectively, according to rules or a service fee set by the system or directory. The system determines a geographic or other location associated with the search request in step 1004. The system then selects an exclusive dedicated directory to be queried based on the one more first keywords, and location in step 1005. In some alternative embodiments, location information is not used as a basis of the query to select the exclusive dedicated directory.

A plurality of directory listings are selected from the exclusive directory that match or linked to the search request first type keywords in step 1006.

Search social network content associated with each of the selected plurality of directory listings is then matched to the search request second type keyword(s) in step 1007

Each of the directory listings of the selected plurality is then ranked according to the frequency of use (or other predefined type of use) of the second type keyword(s) in the social network or media content of each listing in step 1008. The selected directory listings are then rendered on the user interface according to their ranking in step 1009. If desired, for each listing, the portion of the social network or media associated with the listing and containing the second type keyword(s) is rendered on the user interface in conjunction with the listing. Also, if desired, advertising associated or linked with the business listing can be shown with the listing.

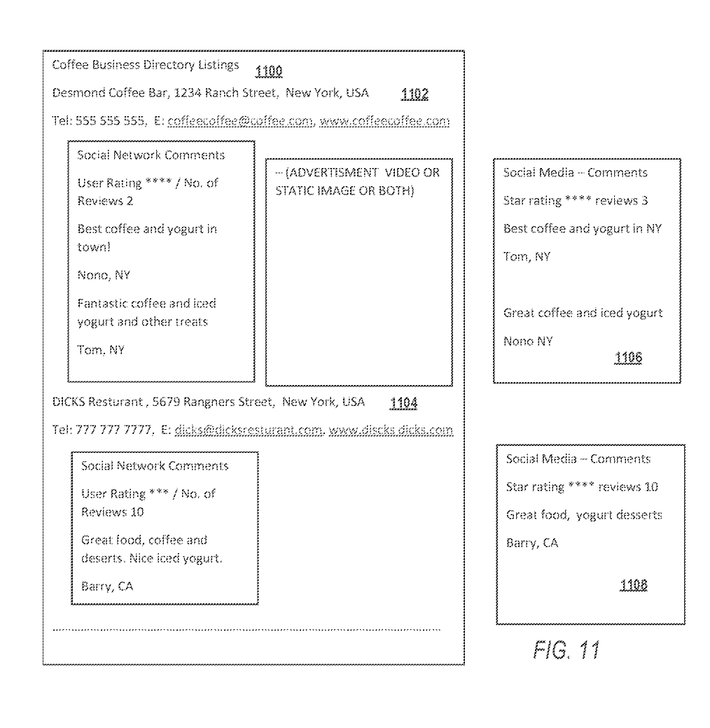

By way of non-limiting example of the aforementioned method, let us assume a user enters the keywords “coffee” and “yogurt” in the search interface provided on a device located in New York (or in a search interface somewhere else but the user has indicated the geographic location New York). The keyword “coffee” is predetermined by the system to be a first type keyword meaning that it is exclusively assigned to the coffee business directory. The keyword “yogurt” is predetermined by the system to be a second type keyword meaning that it is to be matched to the social medial content for each of the coffee business listings in the coffee business directory for New York. The system then determines which coffee business listing has the most occurrences of the term “yogurt” in the social media associated with the listing and ranks this first followed by the next coffee business listing that has the next most occurrences in its social media content. FIG. 11 shows the resulting screen shot 1100 of the search engine user interface for “coffee” and “yogurt” keywords. It will be appreciate that this is but one example and that there can be many categories of business directories and types of business listings and many different first type keywords and second type keywords. For instance in just another example, the first type keyword could be “dinner” and the second type keyword “cinema” and the business listings would be different restaurants that have social media reviews referring to cinema.

In other embodiments, the business listings can be ranked based on other social network parameters associated with the social network content containing the second type keyword(s). For example, the business listings can be ranked based on the number of positive reviews or the number of negative reviews etc. containing the second type keyword(s). A first directory listing 1102 is ranked above a second directory listing 1104 based on the fact that the first directory listing 1102 has a higher social media ranking than the second directory listing 1104. Various social media reviews such as review 1106 and 1108 can be obtained from one or more social media networks or applications. These social media reviews are integrated into the directory listing and used as the basis for ranking the directory listings, in some embodiments. In some embodiments, there may be only a single ranked business listing that is displayed on the user interface.

In some embodiments, a user having a directory listing in the directory has access to the keyword databases (for example via their user directory account or user platform or account associated with the search engine system) and can predefine the first type keywords and the second type keywords associated with the directory and the social network or media content, respectively, according to rules or a service fee set by the system or directory.

In some embodiments, the method of FIG. 10 can include further or alternative steps for ranking the directory listings. By way of example, in some embodiments, as an alternative or addition to step 1008, ranking of the directory listings is based on matching the first and/or second type key words to first and/or second type keywords that a directory administrator, directory account user, or search engine account user has predefined themselves and assigned or linked to their directory listing. This information is stored in the database, listing or other data storage. In this manner, one or more users having a directory listings can each customize first and/or second type keywords and associate them with their particular directory listing for use in the directory listing ranking process. The system matches the keywords entered in the search request against the keywords predefined by the directory listing administrator or owner. For each match found, the directory listing associated with the keyword(s) by the directory listing owner/administrator is selected for the directory ranking process. How the particular selected directory listings are then ranked is determined by rules or the amount of fees paid by the listing owner/administrator for particular keywords.

In some embodiments, the directory listings selected for ranking as a result of matching second keywords of the search request to the second keywords predefined by the directory listing owner/administrator are considered for ranking in addition to the directory listings selected according to the frequency of use (or other predefined type of use) of the second type keyword(s) in the social network or media content of each listing in step 1007. The system can determine the final ranking from this information using heuristic or other types of algorithms by considering frequency of use (or other predefined type of use) of the second type keyword(s), weighting assigned to particular keywords as a result of charges paid by directory listing owners/administrators, and/or other parameters.

In yet other alternative embodiments, the directory queried based on the first type keyword and optionally the location info may not be exclusively linked to the first type keyword but rather be linked to a plurality of directories so that a plurality of business listings taken from the plurality of directories are ranked according to the occurrence of the second type keywords in the social network or media content for some or all of the listings from the plurality of directories.

In yet other embodiments, more types of keywords, instead of only (first and second types) may be predefined for the purpose of searching and ranking the directory listings. Each additional type may be treated by the system for the purpose of selecting the directory and/or for use in ranking the directory listings by the aforesaid methods for ranking first and second type keywords or by different or additional methods.

As already indicated hereinbefore, the search engine server referred to herein can interact with one or more social networks. In one embodiment the social network may be a social network disclosed in PCT application US2014/027153, filed on Mar. 14, 2014 and/or disclosed in international patent application PCT/US2014/027098, filed Mar. 14, 2014, the entire contents of which are incorporated herein. In some other embodiments any other social network may be adopted. In some embodiments, any one of the methods described herein can be implemented within a social network environment itself. In some embodiments, the search engine interface is presented in a website operating environment of a social network user account. In one embodiment, the search directory result is provided independently from the website operating environment of a social network user account whereas in another embodiment the search directory result is embedded in the website operating environment of the social network user account.

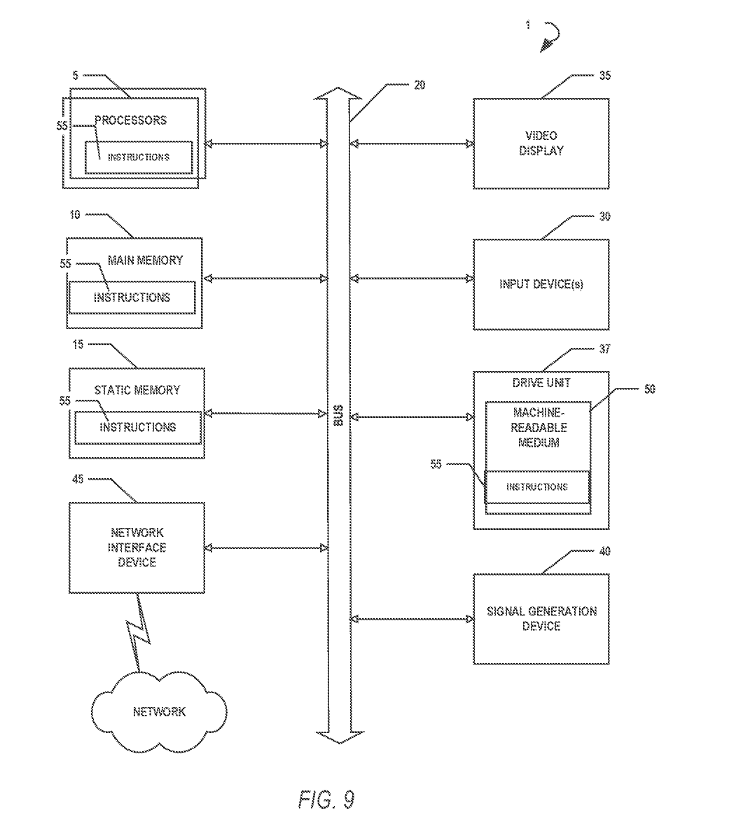

FIG. 9 is a diagrammatic representation of an embodiment of a machine in the form of a computer system 1, within which a set of instructions for causing the machine to perform any one or more of the methodologies discussed herein may be executed. In various example embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a robotic construction marking device, a base station, a personal computer (PC), a tablet PC, a set-top box (STB), a personal digital assistant (PDA), a cellular telephone, a portable music player (e.g., a portable hard drive audio device such as an Moving Picture Experts Group Audio Layer 3 (MP3) player), a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The embodiment of the computer system 1 includes a processor or multiple processors 5 (e.g., a central processing unit (CPU), a graphics processing unit (GPU), or both), and a main memory 10 and static memory 15, which communicate with each other via a bus 20. The computer system 1 may further include a video display 35 (e.g., a liquid crystal display (LCD)). The computer system 1 may also include an alpha-numeric input device(s) 30 (e.g., a keyboard), a cursor control device (e.g., a mouse), a voice recognition or biometric verification unit (not shown), a drive unit 37 (also referred to as disk drive unit), a signal generation device 40 (e.g., a speaker), and a network interface device 45. The computer system 1 may further include a data encryption module (not shown) to encrypt data.

The drive unit 37 includes a computer or machine-readable medium 50 on which is stored one or more sets of instructions and data structures (e.g., instructions 55) embodying or utilizing any one or more of the methodologies or functions described herein. The instructions 55 may also reside, completely or at least partially, within the main memory 10 and/or within the processors 5 during execution thereof by the computer system 1. The main memory 10 and the processors 5 may also constitute machine-readable media.

The instructions 55 may further be transmitted or received over a network via the network interface device 45 utilizing any one of a number of well-known transfer protocols (e.g., Hyper Text Transfer Protocol (HTTP)). While the machine-readable medium 50 is shown in an example embodiment to be a single medium, the term “computer-readable medium” should be taken to include a single medium or multiple media (e.g., a centralized or distributed database and/or associated caches and servers) that store the one or more sets of instructions. The term “computer-readable medium” shall also be taken to include any medium that is capable of storing, encoding, or carrying a set of instructions for execution by the machine and that causes the machine to perform any one or more of the methodologies of the present application, or that is capable of storing, encoding, or carrying data structures utilized by or associated with such a set of instructions. The term “computer-readable medium” shall accordingly be taken to include, but not be limited to, solid-state memories, optical and magnetic media, and carrier wave signals. Such media may also include, without limitation, hard disks, floppy disks, flash memory cards, digital video disks, random access memory (RAM), read only memory (ROM), and the like. The example embodiments described herein may be implemented in an operating environment comprising software installed on a computer, in hardware, or in a combination of software and hardware.

Not all components of the computer system 1 are required and thus portions of the computer system 1 can be removed if not needed, such as Input/Output (I/O) devices (e.g., input device(s) 30). One skilled in the art will recognize that the Internet service may be configured to provide Internet access to one or more computing devices that are coupled to the Internet service, and that the computing devices may include one or more processors, buses, memory devices, display devices, input/output devices, and the like. Furthermore, those skilled in the art may appreciate that the Internet service may be coupled to one or more databases, repositories, servers, and the like, which may be utilized in order to implement any of the embodiments of the disclosure as described herein.

As used herein, the term “module” may also refer to any of an application-specific integrated circuit (“ASIC”), an electronic circuit, a processor (shared, dedicated, or group) that executes one or more software or firmware programs, a combinational logic circuit, and/or other suitable components that provide the described functionality.

The corresponding structures, materials, acts, and equivalents of all means or step plus function elements in the claims below are intended to include any structure, material, or act for performing the function in combination with other claimed elements as specifically claimed. The description of the present technology has been presented for purposes of illustration and description, but is not intended to be exhaustive or limited to the present technology in the form disclosed. Many modifications and variations will be apparent to those of ordinary skill in the art without departing from the scope and spirit of the present technology. Exemplary embodiments were chosen and described in order to best explain the principles of the present technology and its practical application, and to enable others of ordinary skill in the art to understand the present technology for various embodiments with various modifications as are suited to the particular use contemplated.

Aspects of the present technology are described above with reference to flowchart illustrations and/or block diagrams of methods, apparatus (systems) and computer program products according to embodiments of the present technology. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present technology. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

In the following description, for purposes of explanation and not limitation, specific details are set forth, such as particular embodiments, procedures, techniques, etc. in order to provide a thorough understanding of the present invention. However, it will be apparent to one skilled in the art that the present invention may be practiced in other embodiments that depart from these specific details.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” or “according to one embodiment” (or other phrases having similar import) at various places throughout this specification are not necessarily all referring to the same embodiment. Furthermore, the particular features, structures, or characteristics may be combined in any suitable manner in one or more embodiments. Furthermore, depending on the context of discussion herein, a singular term may include its plural forms and a plural term may include its singular form. Similarly, a hyphenated term (e.g., “on-demand”) may be occasionally interchangeably used with its non-hyphenated version (e.g., “on demand”), a capitalized entry (e.g., “Software”) may be interchangeably used with its non-capitalized version (e.g., “software”), a plural term may be indicated with or without an apostrophe (e.g., PE's or PEs), and an italicized term (e.g., “N+1”) may be interchangeably used with its non-italicized version (e.g., “N+1”). Such occasional interchangeable uses shall not be considered inconsistent with each other.

Also, some embodiments may be described in terms of “means for” performing a task or set of tasks. It will be understood that a “means for” may be expressed herein in terms of a structure, such as a processor, a memory, an I/O device such as a camera, or combinations thereof. Alternatively, the “means for” may include an algorithm that is descriptive of a function or method step, while in yet other embodiments the “means for” is expressed in terms of a mathematical formula, prose, or as a flow chart or signal diagram.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

If any disclosures are incorporated herein by reference and such incorporated disclosures conflict in part and/or in whole with the present disclosure, then to the extent of conflict, and/or broader disclosure, and/or broader definition of terms, the present disclosure controls. If such incorporated disclosures conflict in part and/or in whole with one another, then to the extent of conflict, the later-dated disclosure controls.

The terminology used herein can imply direct or indirect, full or partial, temporary or permanent, immediate or delayed, synchronous or asynchronous, action or inaction. For example, when an element is referred to as being “on,” “connected” or “coupled” to another element, then the element can be directly on, connected or coupled to the other element and/or intervening elements may be present, including indirect and/or direct variants. In contrast, when an element is referred to as being “directly connected” or “directly coupled” to another element, there are no intervening elements present. The description herein is illustrative and not restrictive. Many variations of the technology will become apparent to those of skill in the art upon review of this disclosure.

While various embodiments have been described above, it should be understood that they have been presented by way of example only, and not limitation. The descriptions are not intended to limit the scope of the invention to the particular forms set forth herein. To the contrary, the present descriptions are intended to cover such alternatives, modifications, and equivalents as may be included within the spirit and scope of the invention as defined by the appended claims and otherwise appreciated by one of ordinary skill in the art. Thus, the breadth and scope of a preferred embodiment should not be limited by any of the above-described exemplary embodiments.

1. A method, comprising:
receiving, by a search engine server, a search request, the search request comprising one or more keywords;
parsing the search request to locate the one or more keywords in the request;
selecting one or more dedicated directories to be queried based on a domain of the one or more keywords;
selecting a dedicated directory listing from the one or more dedicated directories that matches the domain of the one or more keywords, the directory listing being exclusively linked to the domain; and
providing the dedicated directory listing to a requestor.

2. The method according to claim 1, wherein the dedicated directory listing is exclusively linked to the domain in such a way that no other dedicated directory listings in the one or more dedicated directories associated with the domain can be provided to the client.

3. The method according to claim 1, further comprising:
searching the one or more dedicated directories for advertising linked to the dedicated directory listing; and
providing the advertising to the client.

4. The method according to claim 3, wherein providing the advertising to the client comprises providing a snapshot of the dedicated directory listing in a search engine user interface along with the advertising.

5. The method according to claim 4, wherein the snapshot comprises a user-selected portion of the dedicated directory listing.

6. The method according to claim 5, wherein the snapshot comprises a location of an entity associated with the dedicated directory listing and the keyword.

7. The method according to claim 1, further comprising:
receiving bids from a plurality of entities to link a dedicated directory listing to at least one of the one or more keywords, each of the plurality of entities having or being subscribe to a dedicated directory listing;
selecting a highest bidding one of the bids; and
linking the dedicated directory listing of the entity associated with the highest bidding one of the bids to the at least one of the one or more keywords such that all other of the plurality of entities are excluded from association with the keyword.

8. The method according to claim 1, wherein each dedicated directory listing in the one or more dedicated directories is linked with a unique keyword.

9. The method according to claim 1, further comprising prior to receiving the search request, providing a social network promotion that entices users to search the search engine using the one or more keywords, wherein the social network promotion comprises an offering from an entity, the offering being linked to the one or more keywords.

10. A method, comprising:
receiving, by a search engine server, a search request, the search request comprising one or more keywords;
parsing the search request to locate the one or more keywords in the request;
selecting one or more dedicated directories to be queried based on the one or more keywords;
selecting a dedicated directory listing from the one or more dedicated directories that matches the one or more keywords, wherein each dedicated directory listing in the one or more dedicated directories is exclusively linked to a specific dedicated directory listing to the exclusion of all other dedicated directory listings in the one or more dedicated directories; and
providing the dedicated directory listing to the client.

11. The method according to claim 10, wherein if one or more keywords are not found in the search request, the search engine server performs a default search for the search request.

12. The method according to claim 11, further comprising creating keywords from words included in the search request.

13. The method according to claim 12, further comprising providing the created keywords for bid.

14. The method according to claim 12, further comprising determining a domain associated with the created keywords and selecting one or more dedicated directory listings that correspond to the domain.

15. The method according to claim 10, wherein providing the dedicated directory listing to the client includes providing only the dedicated directory listing and no other search query results with the dedicated directory listing.

16. The method according to claim 10, further comprising determining a location associated with the search request from any of:
content included in the search request; and
location information received from a client device from which the search request was received.

17. The method according to claim 10, wherein each dedicated directory listing in the one or more dedicated directories that is exclusively linked to a specific dedicated directory listing to the exclusion of all other dedicated directory listings in the one or more dedicated directories is further defined by a geographical location.

18. The method according to claim 10, further comprising translating the search request from a source language to a target language, wherein selecting of the dedicated directory listing occurs in the target language and the dedicated directory listing is provided in any of the source language or the target language.

19. A method, comprising:
receiving a search request via a search engine interface, the search comprising keywords;
parsing the search request for the keywords;
locating a first type of keywords in the parsed keywords;
locating a second type of keywords in the parsed keywords;
determining a location associated with the search request;
selecting an exclusive dedicated directory to be queried based on the first type of keywords and the location;
selecting a plurality of directory listings from the selected exclusive directory that match or are linked to the first type of keywords;
searching social network user content associated with each of the plurality of directory listings to match the second type of keywords with keywords contained in the social network user content; and
providing one or more of the plurality of directory listings to the client based on the matching.

20. The method according to claim 19, wherein the one or more of the plurality of directory listings are provided in conjunction with the social network user content associated and the first type of keywords and the second type of keywords.

21. (canceled)

22. (canceled)
